(19) United States
(12) Patent Application Publication
(10) Pub. No.: US 2002/0100670 A1
(43) Pub. Date: Aug. 1, 2002

(54) Two component magnetic sensor assembly

(76) Inventor: Jennifer M. Ambrose, Yardley, PA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/734,405

(22) Filed: Dec. 11, 2000

(51) Int. Cl. H01H 9/04

(52) U.S. Cl. 200/302.1

(57) ABSTRACT

A magnetic sensor assembly having a sensor with an integrally-formed magnet and housing to prevent the loss of the magnet from the sensor and consequent failure of the sensor and ball assembly. The magnet is molded from a liquid mixture of plastic and magnet powder and positioned within the housing so that a portion of the magnet is exposed for direct contact with the ball. The strength of the magnet may be varied by simply adjusting the plastic powder-magnet powder ratio. Because the magnet and the ball are in direct contact when the ball is seated in the sensor, lower energy and less expensive magnetic materials may be used. Moreover, the color of the housing may be changed to reflect different magnet strengths to facilitate placement of the proper sensor in the correct vehicle.

### FIELD OF the INVENTION

This invention relates to a two-component magnetic sensor and ball assembly for interrupting electrical current flow and thereby fuel flow to a vehicle engine upon involvement of the vehicle in an accident.

### BACKGROUND OF THE INVENTION

Explosion of a vehicle after it has been involved in an accident is always a concern. If, after an accident, fuel is still being supplied to the engine, the risk of an explosion increases. A fuel pump supplies fuel to a vehicle engine. Operation of the fuel pump is controlled by a circuit. Current flows through the circuit and powers the fuel pump. A gate in the circuit controls the flow of current through the circuit. When the gate is closed, the circuit is completed and electrical current, supplied by the vehicle battery, flows across the gate and through the circuit. The circuit, in turn, powers the fuel pump to supply fuel to the engine.

Many vehicles are equipped with a sensor and ball assembly that, upon detection of a vehicle crash, interrupts the electrical current powering the vehicle's electrical systems, such as the fuel pump. The ball rests upon and remains in contact with the sensor (which acts similar to a socket) until sufficient impact from a crash is detected.

Traditionally, the sensors have been made from die-cast metal. The sensors have a curved ball seat on the top of the sensor to receive the ball and an opening on the bottom of the sensor. A magnet is inserted into the opening, and a plastic plug is press-fit to cover the opening to prevent the magnet from falling out of the sensor.

In use, the ball sits atop the ball seat of the sensor. The magnetic attraction between the magnet and the ball ensures that the ball stays seated in the sensor until the requisite impact is detected. When the vehicle is impacted sufficiently to break the magnetic attraction between the ball and magnet, the ball disengages from the sensor and hits the gate, thereby opening the gate and stopping the flow of current across the gate and to the circuit board. Consequently, the fuel pump is unable to supply fuel to the engine, thereby reducing the likelihood of an explosion.

The configuration of traditional sensors has proved both problematic and dangerous. Because no adhesive is used to secure the plug in the sensor, the sensor is held together entirely by virtue of the press or friction fit between the plug and the walls of the hollow opening. The integrity of the sensor is dependent, therefore, on the plug remaining in the opening and thereby retaining the magnet in the sensor. Oftentimes, however, the plug (and consequently the magnet) falls out, either during manufacture of the sensor or after the sensor is inserted into the car. Without the magnet facilitating retention of the ball in the sensor, the ball may prematurely unseat from the sensor and thereby interrupt the flow of fuel to the engine unnecessarily. Without fuel to power the engine, the vehicle may be forced to stop at inopportune times and in dangerous locations.

Moreover, because the ball and the magnet are not in intimate contact but rather are separated by the ball seat, a less efficient magnetic circuit is created. Consequently, stronger and more expensive magnets have been necessary in the past to provide the requisite magnetic attraction between the ball and the sensor. The magnets inserted into the sensors traditionally have been made from samarium cobalt (“SmCo”). SmCo is among the most expensive magnet materials available. It has a typical energy product of 26 megagauss-oersteds (MGOe). The energy product is an index that compares magnet materials and their relative strengths, thereby providing the user with a quantitative value to gauge the strength of the magnet. SmCo, with an energy product of 26 MGOe, is extremely strong.

In every application, however, it is vital to ensure that the magnet is not of a strength that will, once the ball disengages from the sensor, pull the ball back into engagement with the sensor. If this occurs, the ball, upon vehicle impact, is not able to open the gate and deactivate the fuel pump. The strength of the magnet, therefore, must be sufficient to retain the ball in the sensor but not so strong as to prevent the ball from disengaging from the sensor upon sufficient impact.

Attaining this balance is further complicated by the fact that vehicles require sensors with different strength magnets. For example, the impact that hitting a pothole (clearly not the impact intended to activate the sensor) can have on a small vehicle is more significant than the impact it can have on a truck. Therefore, the sensor in a small vehicle requires a stronger magnet to prevent the ball from disengaging from the sensor unnecessarily upon such impact. Because a large truck, however, is able to absorb the shock caused by potholes more effectively, the ball is less likely to accidentally disengage from the sensor upon such an impact. A truck, therefore, may not require a sensor having as high a level of magnet strength to protect against premature displacement of the ball.

Because the fully-saturated strength of SmCo is unnecessary for almost every application, the magnets must be calibrated for each different application. In the past, this was done by demagnetizing the SmCo magnets to vary the strength of the magnet and thereby the level of magnetic attraction between the sensor and the ball. During such demagnetization, magnet strength is reduced and essentially wasted. Failure to use the entire energy product available also translates into monetary waste. More importantly, no easy way exists to distinguish sensors having different levels of magnetism. This could lead to sensors having improper magnetic strengths being installed in the wrong vehicles, resulting in failure of the sensor and ball assembly to deactivate the fuel pump (if the magnet is too strong to allow release of the ball) or premature deactivation of the fuel pump (if the magnet is too weak to prevent release of the ball).

It is an object of the present invention to improve the integrity of the sensors by integrally-forming the magnets in the sensors.

It is another object of the present invention to provide sensors that readily evidence their magnetic strengths to facilitate differentiation between sensors of different strengths.

It is yet another object of the present invention to provide a sensor allowing for intimate contact between the ball and the magnet.

It is a further object of the present invention to provide a sensor manufactured from less expensive magnetic materials.

It is another object of the present invention to provide sensors calibrated for different applications without significant waste of magnetic strength during the calibration process.

### SUMMARY OF THE INVENTION

The magnetic sensor assembly of the present invention addresses the problems of previous sensors by providing a sensor having an integrally-formed magnet and housing to thereby prevent the loss of the magnet from the sensor and consequent failure of the sensor and ball assembly. The magnet is molded from a liquid mixture of plastic and magnet powder and positioned within the housing so that a portion of the magnet is exposed for direct contact with the ball. The strength of the magnet may be varied by simply adjusting the plastic powder-magnet powder ratio. Because the magnet and the ball are in direct contact when the ball is seated in the sensor, lower energy and less expensive magnetic materials may be used. Moreover, the color of the housing may be changed to reflect different magnet strengths to facilitate placement of the proper sensor in the correct vehicle.

### BRIEF DESCRIPTION OF THE DRAWINGS

FIG. 1 is an exploded perspective view of one embodiment of the sensor.

FIG. 2 is a top plan view of the sensor of FIG. 1.

FIG. 3 is a cross-sectional view of the sensor of FIG. 1.

FIG. 4 illustrates a ball seated in the sensor of FIG. 1.

### DETAILED DESCRIPTION OF THE DRAWING

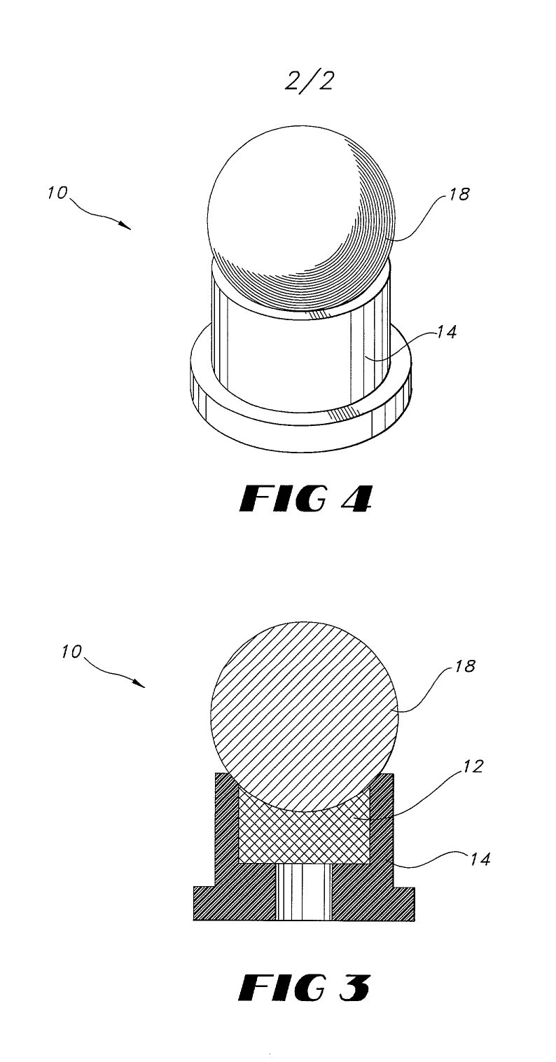

FIG. 1 illustrates the sensor 10 of an embodiment of the present invention. The sensor 10 includes a magnet 12 and a housing 14 which surrounds the magnet 12. The housing 14 may be made from any durable material that is able to withstand heat to prevent the housing from bending or melting at high temperatures, but is preferably made from a plastic such as polyphenolene sulfide (PPS). While a preformed magnet could be inserted into and adhered to the housing using adhesive or mechanical locking means, injection molding is the preferred magnet insertion method. The magnet is preferably molded of polymer-bonded magnet material. Magnet powder and plastic powder are mixed and heated until the plastic becomes molten. The molten mixture is then injection molded into the housing and hardens almost instantaneously. Alternatively, the housing may be molded around an already-molded magnet. Integral formation of the magnet 12 with the housing 14 eliminates the risk of separation and loss of the magnet 12 from the sensor 10. Moreover, exposure of the magnet 12 in the ball seat 16 (the top of the sensor 10 that seats the ball 18, as shown in FIGS. 3 and 4) facilitates intimate contact between the magnet 12 and the ball 18. Such intimate contact creates a more efficient magnetic circuit and thereby allows for use of cheaper magnets having lower energy products.

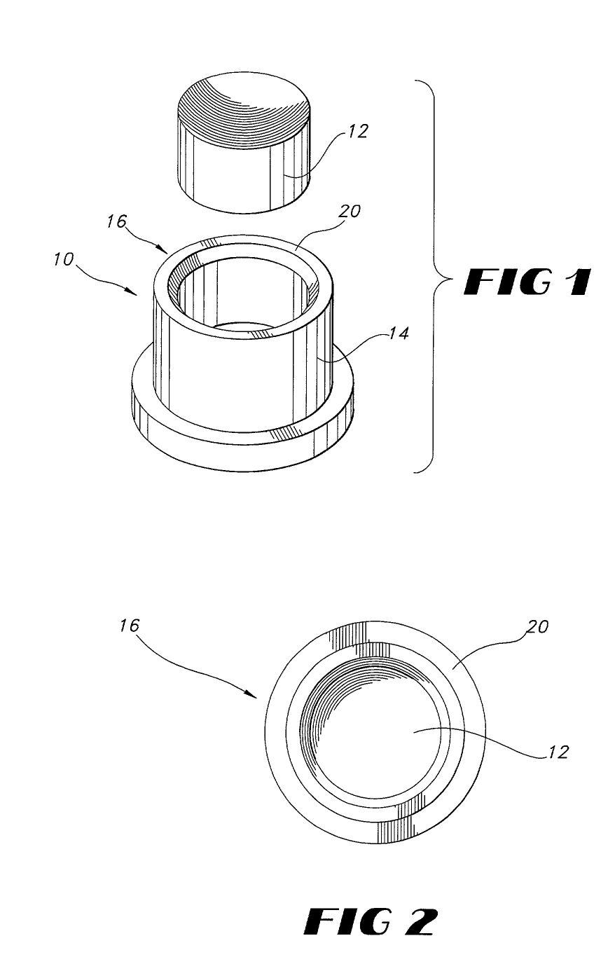

While the ball seat 16 could be made entirely from the magnetic material, the magnetic material preferably does not encompass the entirety of the ball seat 16, as shown in FIG. 2. Consequently, the diameter of the magnet 12 is preferably smaller than the diameter of the ball 18. This helps reduce the risk that the magnet 12 will draw the ball 18 back into the ball seat 16 upon disengagement of the ball 18 and sensor 10. Moreover, molding the edges 20 of the ball seat 16 from non-magnetic material, such as plastic, imparts physical strength to the edges 20. The edges 20 of the ball seat 16, which serve as barriers to help retain the ball 18 in the sensor 10 until the proper force acts on the sensor 10, therefore, are less likely to chip or wear.

Use of magnetic powder and plastic powder eliminates the need to calibrate the sensors by demagnetizing the magnets to reduce and vary their strengths for different applications. Instead, to vary the strength of the magnets of the present invention, different ratios of magnet powder and plastic powder are used. To increase the magnetic strength of the sensor, the amount of magnet powder used to form the magnet is simply increased; to decrease the magnetic strength of the sensor, the amount of magnet powder used to form the magnet is simply decreased. Because the housing is preferably made of plastic, it may be manufactured in different colors, where each color represents a different magnetic strength. Sensors with different magnetic strengths are thereby easily distinguishable, thus facilitating placement and use of sensors with the proper magnetic strength in the correct application.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims.

We claim:

1. A magnetic sensor assembly comprising a sensor comprising:
a. a housing; and
b. at least one magnet integrally-formed with the housing.

2. The magnetic sensor assembly of claim 1, wherein the housing is substantially cylindrical in shape.

3. The magnetic sensor assembly of claim 1, wherein the housing comprises plastic.

4. The magnetic sensor assembly of claim 1, wherein the at least one magnet is injection-molded into the housing.

5. The magnetic sensor assembly of claim 1, wherein the housing is injection-molded around at least a portion of the at least one magnet.

6. The magnetic sensor assembly of claim 1, wherein the sensor further comprises a seating surface.

7. The magnetic sensor assembly of claim 1, further comprising a ball adapted for magnetic attraction to the at least one magnet, wherein the assembly is located within a vehicle and the attraction between the ball and magnet may be overcome upon application of a sufficient force upon the vehicle.

8. The magnetic sensor assembly of claim 6, wherein at least a portion of the at least one magnet is exposed in the seating surface.

9. The magnetic sensor assembly of claim 1, wherein the magnet comprises plastic.

10. A magnetic sensor assembly comprising:
a. a plastic housing; and
b. at least one magnet integrally-formed with the housing to form a seating surface, wherein the at least one magnet is located within the housing so that at least part of the at least one magnet is exposed in the seating surface.

11. The magnetic sensor assembly of claim 10, further comprising a ball for engaging the seating surface.

12. A method of manufacturing a magnetic sensor assembly comprising integrally-forming at least one magnet with a housing.

13. The method of claim 12, wherein the at least one magnet and the housing are integrally-formed by heating a mixture comprising plastic powder and magnetic powder until the mixture is molten and injection-molding the mixture into the housing to form the at least one magnet.

14. The method of claim 12, wherein the at least one magnet and the housing are integrally-formed by heating a mixture comprising plastic until the mixture is molten and injection-molding the mixture around at least a portion of the at least one magnet to form the housing.

15. A magnetic sensor assembly comprising:
a. a plastic, substantially cylindrical-shaped housing; and
b. at least one magnet integrally-formed with the housing to form a seating surface, wherein the at least one magnet is located within the housing so that at least part of the at least one magnet is exposed in the seating surface; and
c. a ball seatable in the seating surface and adapted for magnetic attraction to the at least one magnet,
wherein the assembly is located within a vehicle and the attraction between the ball and magnet may be overcome upon application of a sufficient force upon the vehicle.

16. A two component assembly for a shock sensor comprising a ball and a magnetized socket to receive the ball, wherein the magnetized socket comprises a housing and a magnet integrally-formed with the housing so that the magnet intimately contacts the ball when the ball is seated in the socket.

17. The assembly of claim 16, wherein the magnet is molded from a magnetic material and a polymer material.

18. The assembly of claim 17, wherein the housing indicates the strength of the magnet integrally-formed with the housing.

19. The assembly of claim 18, wherein the color of the housing indicates the strength of the magnet integrally-formed with the housing.

20. The magnetized socket of the two component assembly for a shock sensor claimed in claim 16.
